(19) United States
(12) Patent Application Publication
(10) Pub. No.: US 2013/0206848 A1
(43) Pub. Date: Aug. 15, 2013

(54) POINT OF SALE MANUFACTURE OF PRODUCTS WITH A GENERAL DECAL AND PERSONALIZED LABEL INCLUDING SECURITY CODE

(71) Applicant: Norskman, Inc., (US)

(72) Inventor: David J. Kane, Arlington Heights, IL (US)

(73) Assignee: Norskman, Inc., Arlington Heights, IL (US)

(21) Appl. No.: 13/706,735

(22) Filed: Dec. 6, 2012

Related U.S. Application Data
(60) Provisional application No. 61/567,441, filed on Dec. 6, 2011.
(60) Provisional application No. 61/610,814, filed on Mar. 14, 2012.

(51) Int. Cl. G09F 3/00; B32B 38/00

(52) U.S. Cl. CPC G09F 3/0297; B32B 38/145
USPC 235/494; 428/41.5; 156/277; 235/487

(57) ABSTRACT

A method for personalized labeling of decal decorated item at a point of sale for consumer by laminating a personal label on or adjacent a preexisting decal applied to the item. The personal label may comprise an access code to a secure information source, identification information or a greeting.

### CROSS REFERENCE TO RELATED APPLICATIONS

This is a utility application incorporating by reference and claiming priority to provisional application Ser. No. 61/567,441 filed Dec. 6, 2011 entitled “Point of Sale Manufacture of Products with a General Decal and Personalized Label” and Ser. No. 61/610,814 filed Mar. 14, 2012 entitled “Point of Sale Manufacture of Products with a General Decal and Personalized Label Including Security Code”.

### BACKGROUND OF THE INVENTION

In a principal aspect the present invention relates to a product, such as a ceramic mug, which incorporates a generic decal with a personalized label as part of or on the generic decal affixed to the product. The invention relates to the product and method for manufacture of the product.

Numerous items are sold and distributed as novelties or as memorabilia. For example, decorated mugs, glass containers or drinkware, stainless steel containers or drinkware, porcelain plaques, key chains and many other items of a similar nature are distributed as memorabilia. As such, decoration for items of this nature may include a decal or otherwise imprinted image thereon. The image typically is a generic image which is applied to the item as a decal. As a consequence, such items are not necessarily personalized with a name, date or other information associated with the purchaser of the item.

To personalize such items for marketing at a point of sale, purveyors prepare or have others prepare numerous alternative personalized items which include a generic design or scene coupled with a unique feature such as a name. Consequently, the purveyor is required to maintain a large inventory of the prep-personalized items. Even in such a circumstance not all likely or possible unique features will be maintained in an inventory.

Thus, there has developed a need for methodology by which novelty items and other memorabilia can be personalized at a point of sale in an efficient and inexpensive manner without employing highly skilled or highly trained workers.

There has also developed a need to provide means for identifying the person who has acquired the personalized item. For example, if the person receiving or procuring the item is injured or lost, the item may provide a confidential means for identifying that person as well as a means to enable that person or an aid worker to have access to helpful information.

### SUMMARY OF THE INVENTION

Briefly the present invention provides a technique and a resultant product or item which incorporates a standardized label or decal that may be easily individualized of a point of sale or display by adding a personalized label at the point of sale or display. The method and product of the invention enable use of safe, organic, material decals wherein a large inventory of the generic design starting products may be generated and maintained for point of sale personalization and distribution at some later date.

As an aspect of the invention, the inventory of products may be personalized by affixing a label to a designated region or portion of the item on which a generic decal has been placed. For example, the name of the individual purchasing the product, a certain date or location or other information may be imprinted on a label which is then attached or affixed to the generic decal that is already in place affixed to the product.

As another aspect of the invention the decal may be made of an organic material which includes resin that facilitates, in a synergistic manner, the application of a customized or personal label.

As a further aspect of the invention the label may be customized at the point of sale, and as an additional aspect the customized label may comprise a laminate of multiple layers of plastic materials.

As yet a further aspect, a label that includes an acrylic adhesive provides especially strong adherence of the personalized label to a decal or equivalent generic design element.

As yet another aspect of the invention, acrylic adhesive alone or in combination with resin associated with a generic label attached to the item maintained in inventory facilitates adherence and retention of the label on the item or product which is being personalized.

As yet another aspect of the invention a separate polyurethane protective layer may be placed over the label prior to affixation to the decal on the item or subsequent to placement of the label on the decal or design on the product or item at a point of sale.

As an aspect of the invention is the point of sale distributor of the product no longer needs to maintain multiple items in inventory which are pre-labeled with personalized names, dates or the like. The process and the product enable purchasers of an item to create the personalized text and the message that they wish to include on the product within a designated space of a design or decal in a prompt and efficient manner. Unnecessary inventories of pre-labeled products may therefore be avoided.

As another aspect of the invention, multiple types of products including containers, plaques, tags and the like may be prepared using the techniques of the invention wherein the surface of the item to be personalized will include a generic decal and is personalized at the point of sale by printing and application of the label in accord with the consumer's desire.

As another aspect of the invention, the personalized label may include a personalized code which is machine readable and may provide helpful information for the person or about the person. Thus, the label may enable access to health records, personal information, or general information that the person may find useful. Application of the personalized label on a key tag, name tag, jewelry item or any other item may thus be relied upon to provide emergency information unique to the person possessing the item.

These and other objects, advantages and features of the invention will be set forth in the detailed description which follows.

### BRIEF DESCRIPTION OF THE DRAWING

in the description which follows reference will be made to the drawing comprised of the following Figures:

FIG. 1 is an exemplary specimen of a decal which may be applied to a container such as a ceramic mug;

FIG. 2 is an isometric view of the decal of FIG. 1 as applied to a ceramic mug wherein an individually personalized label has been affixed thereto;

FIG. 3 is a view of yet another decal which may be applied, for example, to a mug such as a ceramic mug and which further includes a designated area for application of a personalized label;

FIG. 4 is a view of a mug as shown in FIG. 3 having a generic decal applied thereto and further including a personalized label affixed to the decal;

FIG. 5 is a flow chart illustrating steps in the practice of embodiment of the invention.

### DESCRIPTION OF EMBODIMENTS OF THE INVENTION

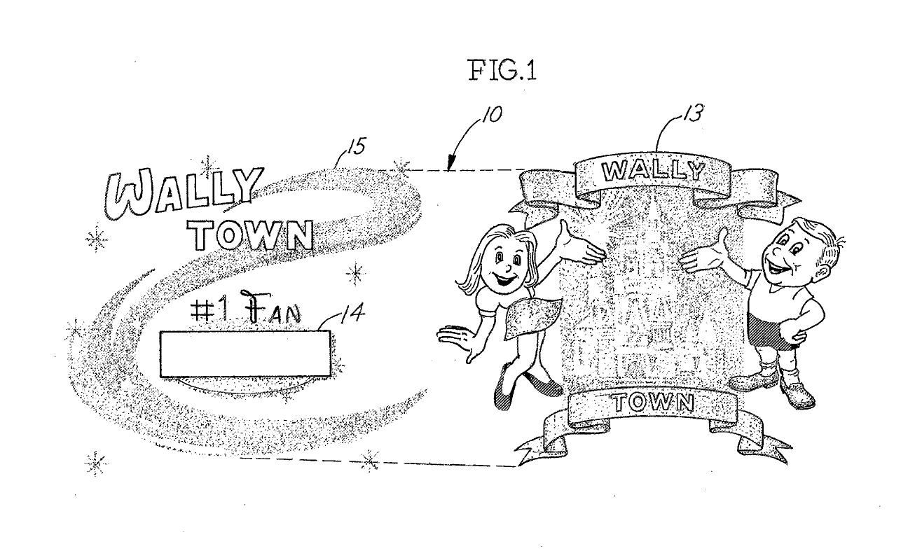

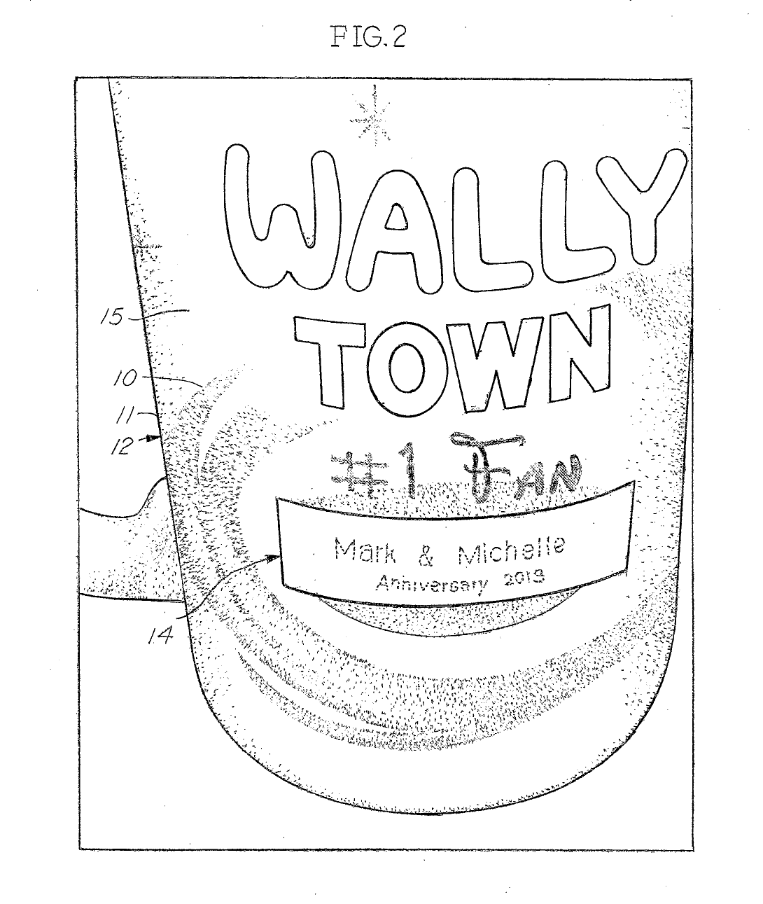

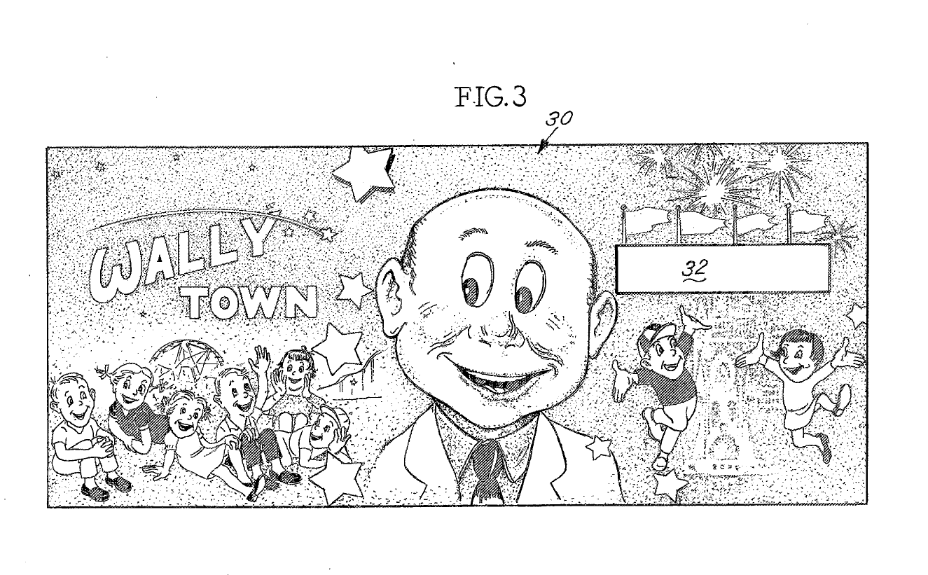

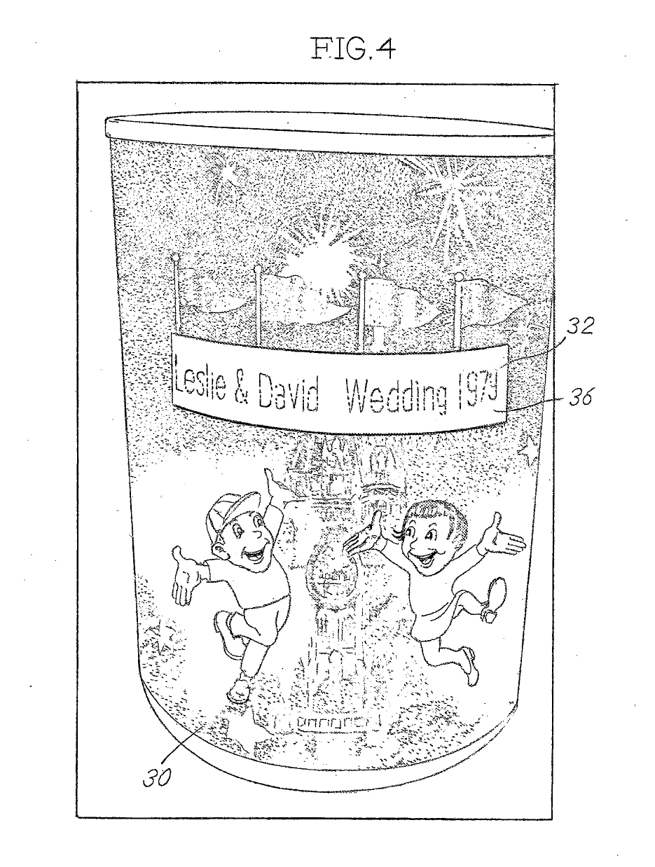

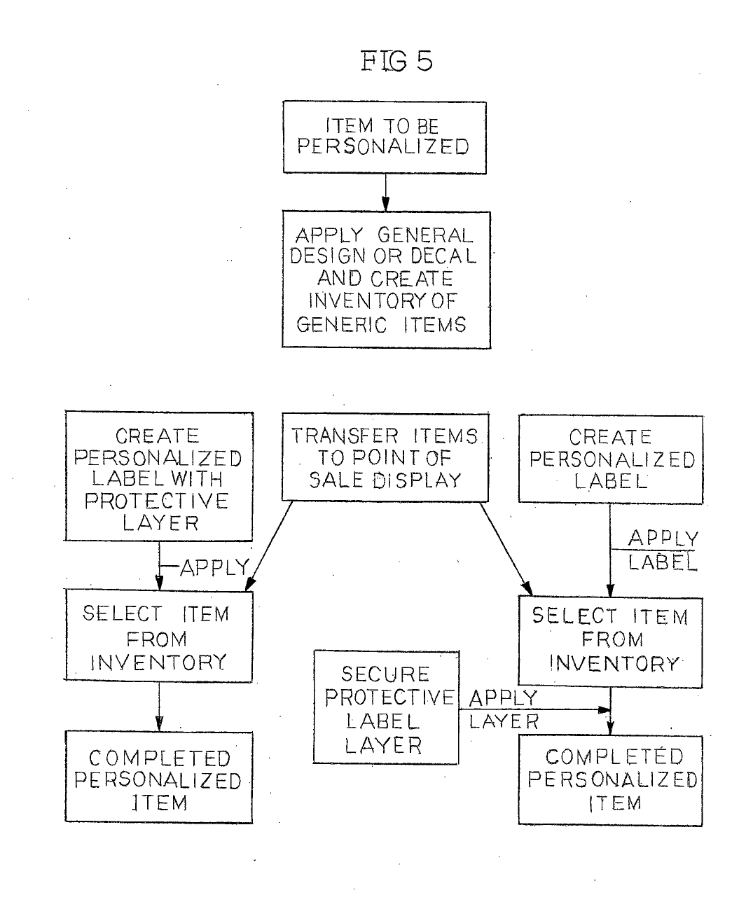

Referring to the FIGS., two examples of embodiments of the invention are depicted. FIGS. 1 and 2 illustrate a first embodiment. FIGS. 3 and 4 illustrate a second embodiment. FIG. 5 is a flow chart illustrating the methodology of the invention which enables point of sale creation of a personalized message or statement on an item having a generic design.

Referring to FIGS. 1 and 2 and in particular FIG. 1, there is illustrated a two part decal 10. The decal 10 is in a generic form and includes a consistent, common, thematic visible illustration which is incorporated in the decal 10. The decal 10 itself may be any of a number of known decal types. Preferably as an aspect of the invention, an organic material decal may be used to address environmental and toxicity concerns. In any event, the illustrative decal 10 may be affixed to an outside surface 11 of a container 12 such as a mug. The methodology for attachment of the decal is described as follows:

Various brands and types of decals may be affixed to the outside surface of the item using conventional alignment techniques such as alignment jigs. The decal 10 includes a first part or section 13 which is wrapped around a portion of the container 12 and a second part or portion 15 which is wrapped around an adjacent section or part of the container 12. The second portion 15 includes an identified region or location 14 which is designated to receive a personalized note, message or information.

HG. 2 illustrates the application of the decal 10 to the container 12. Thus container 12 includes the decal portion 15 attached or affixed thereto. The region 14 for receipt of personalized information has received a specific label 18 which is adhered or affixed to the outer surface of decal 12. Typically the decal 12 will include a resin material incorporated therein. The attached label 18 is typically a multiple layer laminated plastic materials construction. The laminated construction includes a releasable backing with an adhesive such as an acrylic adhesive which attaches the releasable backing to laminated layers of plastic material. The label 18 is thus flexible and upon removal of the backing may be adhered in the location region 14 of the decal 10. The acrylic adhesive is, in a version of the invention, synergistic with the resin material associated with the decal 10 to improve adherence when used in combination.

The label as described is a laminate such as the type TZ laminate offered by and available from Brother International Corporation as an element of its P-touch® Labeling System. A wide range of such labels as well as associated labeling machines (such as available as an element of the referenced P-touch® System) permit printing on the label to provide a personal message or information such as depicted in FIG. 2. That is, the mug or container 12 may be part of inventory or pre-manufactured mugs having identical or substantially identical construction and generic design decals or elements affixed thereto. The inventory is then maintained at the point of sale for the product. At that same point of sale, labeling equipment may be used to quickly make a personalized label 18 which is then adhered to the outside surface of the of the adhered decal 10. A benefit or aspect of the invention utilizing the P-touch System results because the custom printing or design is sandwiched between layers of laminate plastic and thus is protected from abrasion and contamination.

As an additional feature, the label 18 may include on its outside surface a polyurethane material layer such as offered by 3M Company, St. Paul, Minn. as Polyurethane Protective Tape, product number 8674. Alternatively, a separate dispenser may be used to dispense a portion of a protective polyurethane material layer to cover the affixed label 18 at the point of sale and following placement of label 18 on the decal 10. Thus, the protective layer may be pre-sized and precut to place over and on the label 18.

FIGS. 3 and 4 illustrate another embodiment wherein a decal 30 is pre-manufactured with a particular design thereon. The decal 30 includes a designated section or region 32 for attachment of a label. The decal 30 is initially placed upon a container such as a glass, metal or porcelain container 34 in FIG. 4 using conventional techniques. An inventory of such containers having a standard generic decal 30 thereon are then made available at a point of sale. A separate label 36 is then generated at the point of sale. The label 36 is of the type depicted in FIG. 2. The label 36 is positioned in the designated region or area 32.

The resultant product thus may be completed on a personalized basis at a point of sale. Utilizing the various elements described above in an embodiment of the invention enables an attendant at the point of sale to prepare the personalized item in a matter of seconds and certainly less than one minute. Thus, an item of memorabilia can be easily created at a point of sale utilizing a large inventory of starting materials, items or products which are customized at the point of sale in a straightforward, easy manner.

FIG. 5 illustrates the series of steps that occur with respect to the practice of the embodiment of the invention. That is, a flow chart sets forth the stages or activities that occur in a manufacturing site to create a large inventory of generic items. The items or starting materials are then transferred to the point of sale where the appropriate labeling materials as described above are made available for completion in terms of the message that is to be attached to the item that is being personalized,

It is contemplated that various types of materials may be used for the decals that are applicable including the following: waterslide decals, appliques and any adhesive adhered generic label.

The labeling materials may be utilized and provided from various sources. A particularly useful source is the P-touch System tapes and associated elements previously referenced. Such tapes are available in multiple sizes and colors and may be imprinted with multiple designs, graphics and printing in various languages.

The material which provides a protective layer over the label may be provided as a tape which is applied after the label is applied or alternatively may comprise the outer surface of the tape that is provided in the second step set forth above. More specifically the polyurethane materials as sourced from 3M Company provide excellent protection for the labels.

The techniques and subject matter of the invention further include combinations of the labeling system with quick response codes (QR codes for example). That is, a code personalized for an individual may be imprinted upon an item. Such an imprinting utilizing techniques of application as set forth herein thereby immediately provides a high security yet extremely personal identifier for individuals. This combination of elements has multiple uses.

For example, if a person has a bracelet with their own personalized QR code thereon and a medical emergency occurs with respect to that person, the code, which is machine readable, can immediately be read by emergency personnel to facilitate the identification and the medical history, for example, as well as other pertinent information associated with that individual. Thus, personal health information may be accessed using this technique.

Another example illustrates the combination of the features and elements that comprise the invention: if a family attends a theme park, each member of the family as they enter the park may receive a charm or tag that is placed on a badge or key chain or the like. Each of the tag items may contain a personalized or a theme park QR code. Thus, each of the children in the family will have a code as will each of the adults. The QR code is personalized in that certain information such as the name, address and appropriate phone numbers may be included or so that access is possible through the code to the theme park registration authorities in order to protect privacy and provide additional useful information. In any event, if the child becomes lost, by way of example, the machine readable code can be easily accessed and read and the child may be more easily united with the parents.

Further, the code can include code information relating to the theme park that is accessible by use of a personal smart phone. The locations of rides, other park attractions, food service and emergency service locations can all be accessed by the individual having the personalized code which is provided as part of the admission process to the park.

Thus, placement of a QR code or some other machine readable code on an item such as a novelty item, a gift card, a medallion, a badge, a key chain or a dog tag upon payment for a ticket to an event and receipt of a personalized entry tag may enable not only access to information associated with the park but also provide information which will enhance the comfort and safety of the individual who has entered the park.

Further, utility associated with the combination of a code, such as a QR code that is unique to an individual, maybe incorporated in a label placed on an item such as a key chain or bracelet in a manlier described herein and may be protected by a layer of a polyurethane material as described herein to enable individuals to have access to their own health record system and, in the case of an emergency, will enable responders to have access, for example, to appropriate information associated with an individual needing aid. A health care or health product provider may provide coded personal labels on badges or tags, for example. Such labels affixed to such a badge as described will be machine readable and could contain personal information such as health care information for that individual such as prescription requirements, blood type, allergies, etc.

The Quick Response (QR) code is a matrix bar code or two dimensional code that is standardized, encodes appropriate data and is machine readable. It was developed originally for the manufacturing industry. Utilization of such a code, by way of example, in combination with the other elements described herein expands the benefits associated with such a code. The invention, however, is not limited to a particular code but may include additional schemes or types of codes including standard bar codes and other optical or other types of readable codes that can be applied by means of a label to an item on an individual by individual basis. The described examples comprise only a few examples of the myriad that are possible using a combination of various elements as set forth herein.

Thus, variations with respect to the practice of the invention and the creation of a product are limited only by the following claims and equivalents thereof.

What is claimed is:

1. A personalized decal assembly for products comprising:
(a) a product having an application substrate surface
(b) a generic design decal consisting of an adhesive film selected from the group consisting of a label having an adhesive material on an inner surface, an outer surface, a generic design visibly apparent when said outer surface is viewed, and a locator region on the outer surface, said decal inner surface applied to the substrate surface of the product; and
(c) a separate, uniquely printed printable tape label affixed to the locator region, said tape label comprising laminated combination of layers including an acrylic adhesive separating a removable layer from a printed layer.

2. The assembly of claim 1 wherein the decal is an organic, lead free material.

3. The assembly of claim 1 further including a polyurethane outer layer covering a laminated acrylic tape label.

4. The assembly of claim 2 farther including a polyurethane outer layer covering the tape label.

5. The assembly of claim 1 wherein the product substrate surface is selected from the group consisting of porcelain, ceramic, metal, wood, glass and combinations thereof.

6. The assembly of claim 1 wherein the decal includes a resin coating on the outer surface for adherence of the label.

7. A method for personalizing an individual product item in an inventory of like items comprising the steps of:
(a) assembling an inventory of generally like items, each item in the inventory having an outer substrate surface, each item in the inventory having a pre-applied decal, said decal having a substantially same decal design, each decal design including a fixed location region;
(b) selecting one item from the inventory
(c) separately printing a tape label, said tape label comprising a laminated combination of plastic layers including an acrylic adhesive layer separating a removable layer from a print receiving layer;
(d) printing a custom legend on the print receiving layer;
(e) separating the removable layer from the label; and
(f) applying the acrylic adhesive layer and attached label layers to the location region.

8. The method of claim 7 including the step of applying a polyurethane tape layer over and on the label layers affixed to the location region.

9. The assembly of claim 1 wherein the label further includes a machine readable code.

10. The assembly of claim 9 wherein the code is a QR code.

11. The assembly of claim 9 wherein the code comprises a means for access to personal information of a select individual.

12. The assembly of claim 9 or 11 wherein the code comprises a means for access to generic information.
